(19) United States
(12) Patent Application Publication
(10) Pub. No.: US 2026/0328335 A1
(43) Pub. Date: Oct. 22, 2026

(54) CALIBRATION PANEL HOLDING APPARATUS

(71) Applicant: Robert Bosch GmbH, Stuttgart (DE)

(72) Inventors: Christian Staengle, Hallstadt (DE); Georg Wagner, Filderstadt (DE); Mauro Disaro, Stuttgart (DE)

(21) Appl. No.: 19/109,591

(22) PCT Filed: Sep. 14, 2023
(86) PCT No.: PCT/EP2023/075298

§ 371 Date: Mar. 7, 2025

(30) Foreign Application Priority Data
Sep. 14, 2022 (DE) 10 2022 209 627.4
Sep. 13, 2023 (DE) 10 2023 208 894.0

(51) Int. Cl. F16M 11/04; G06K 7/10; G06T 7/80

(52) U.S. Cl. CPC F16M 11/046; G06K 7/10297; G06T 7/80

(57) ABSTRACT

A holding apparatus for mounting and holding a calibration panel on a stand. The holding apparatus includes a mechanical connecting device which is configured to connect the holding apparatus to the stand; a holder which allows the calibration panel to be attached to the holding apparatus; a sensor device configured to provide data which allow the current position of the holding apparatus on the stand to be determined; and a transmitting device configured to transmit the data which allow the current position of the holding apparatus to be determined.

### FIELD

The present invention relates to a holding apparatus for mounting and holding calibration panels, which are intended for calibrating driver assistance systems in motor vehicles, on a calibration device.

### BACKGROUND INFORMATION

To calibrate driver assistance systems installed in motor vehicles, in particular in the workshop field, calibration devices are used, which have at least one measuring panel (“calibration panel”). At least one optical pattern is formed on the at least one calibration panel and is optically detected by an image capture device of a driver assistance system to be calibrated in order to calibrate the driver assistance system.

In order to be able to calibrate a driver assistance system with the required accuracy, the position and orientation of the calibration panel(s) in front of the motor vehicle must be set as precisely as possible to values specified by the manufacturer of the driver assistance system to be calibrated.

### SUMMARY

It is an object of the present invention to improve and in particular to simplify the positioning of calibration panels, which are provided for calibrating driver assistance systems, in front of a motor vehicle.

The present invention comprises a holding apparatus for mounting and holding a calibration panel, in particular an optical calibration panel, on a stand of a calibration device.

According to an example embodiment of the present invention, the holding apparatus has: a mechanical connecting device which is designed to connect the holding apparatus to the stand in a movable and optionally lockable manner, so that the holding apparatus is supported by the stand; a holder which allows the calibration panel to be mounted on the holding apparatus; and a sensor device which is designed to provide data which allow the current position of the holding apparatus on the stand to be determined. The holding apparatus also comprises a transmitting device and/or an output device.

The transmitting device is configured to transmit data which allow the current position of the holding apparatus to be determined so that these data can be received by a corresponding receiving device.

The output device allows data and/or instructions to be output to a user of the calibration device. The output device can in particular comprise a display device which allows optical displays to be output to a user. In this way, the user can be shown the current position of the holding apparatus and/or instructions on how to correctly position the holding apparatus.

The present invention also includes a calibration device, in particular a calibration device for calibrating an image capture device of a driver assistance system. According to an example embodiment of the present invention, the calibration device comprises a stand and at least one holding apparatus according to the present invention, which can be mounted on the stand. The calibration device can in particular comprise a support or arm which is mounted on the stand in a height-adjustable manner. The at least one holding apparatus can be mounted on the height-adjustable support or arm in a displaceable and optionally fixable manner.

The present invention further comprises a method for determining a position of a calibration panel, in particular an optical calibration panel, which is mounted on a calibration device according to the present invention. According to an example embodiment of the present invention, the method comprises using the at least one sensor device to collect data that allow the current position of the holding apparatus on the calibration device to be determined. The method further comprises transmitting the data which represent the determined position of the holding apparatus on the calibration device using a transmitting device, and/or outputting or displaying the data using an output device.

The present invention also comprises a method for positioning a calibration panel, in particular an optical calibration panel, on a calibration device according to the present invention. According to an example embodiment of the present invention, the method comprises mounting the calibration panel on the holding apparatus, determining the position of the holding apparatus on the calibration device using a method according to the present invention as described above, and changing the position of the holding apparatus until the determined position of the holding apparatus corresponds to a specified position.

A holding apparatus according to the present invention, a calibration device according to the present invention and the methods according to the present invention make it possible to determine the current position of a calibration panel in relation to the stand of the calibration device easily and with high accuracy with the aid of the at least one sensor device.

In these ways, the calibration panel can be positioned quickly and reliably at a desired or specified position on the calibration device. The risk of errors in the calibration of the driver assistance system, which can result from incorrect positioning of the calibration panel, can thereby be reduced.

In one example embodiment of the present invention, the at least one sensor device comprises at least one optical sensor which is designed to read an optically readable scale which is mounted or formed on the calibration device in order to determine the current position of the holding apparatus and thus also the current position of the measuring panel on the calibration device. The optically readable scale can comprise a human-readable scale, e.g. a scale with digits. Additionally or alternatively, the scale can comprise a particularly well machine-readable scale, e.g. a barcode.

A combination of an optical sensor and an optically readable scale which can be read by the optical sensor is simple to implement, since existing optical scales, e.g. measuring tapes and meter sticks, which are formed on the calibration device, can be used as scales.

In one example embodiment of the present invention, the at least one optical sensor is designed to detect an optical pattern formed on a floor in order to be able to check the position of the optical pattern on the floor. The optical pattern can in particular be formed on a mat which is located on the floor. The pattern can be provided to calibrate cameras, such as rear-view Cameras, of the motor vehicle.

The at least one optical sensor can also be designed to optically detect and check the position of at least one radar reflector provided for calibrating radar sensors of the motor vehicle.

In one example embodiment of the present invention, the holding apparatus has at least one angle sensor which allows a roll angle and/or pitch angle of the support to be determined. The at least one angle sensor can in particular be equipped with an angle sensor display device which can be read by the at least one optical sensor of the sensor device. In this way, the values ascertained by the at least one angle sensor can be read automatically and made available for further evaluation.

In one example embodiment of the present invention, the holding apparatus additionally has an illumination device which is designed to illuminate at least the region of the optically readable scale which is read by the optical sensor. Depending on the sensitivity of the optical sensor, the illumination device can emit light in the visible range, the infrared range and/or the UV range to illuminate the scale.

In one example embodiment of the present invention, the at least one sensor device comprises at least one magnetic sensor and/or at least one mechanical sensor. In such an embodiment, the scale is designed such that it is readable by a magnetic sensor and/or by a mechanical sensor.

Magnetic and mechanical sensors work reliably even in unfavorable lighting conditions. Magnetic sensors are also insensitive to soiling and mechanical wear of the scale. They therefore have a high level of operational reliability.

In one example embodiment of the present invention, the holding apparatus additionally comprises a data processing device which is designed to process the data provided by the at least one sensor device in order to determine the current position of the holding apparatus on the stand.

In this way, the current position of the holding apparatus can be determined autonomously by the holding apparatus and optionally displayed on a display device. This can make it considerably simpler to adjust the desired position of the holding apparatus and of the calibration panel.

In an alternative embodiment of the present invention, the data processing device can be provided separately from the holding apparatus. This can reduce the weight and cost of the holding apparatus.

In one example embodiment of the present invention, the holding apparatus additionally comprises an identification device which makes it possible to identify a calibration panel arranged in the holder of the holding apparatus. In this way, the desired position of the holding apparatus on the stand can be determined depending on the currently used calibration panel which has been identified by the identification device. If required, the calibration panel used and identified can be logged for later evaluation, e.g. in a calibration log.

In particular in the case of calibration systems which are used alternately with different calibration panels, automatically identifying the currently used calibration panel with the aid of an identification device can reduce the risk of using an incorrect calibration panel which is not suitable for the driver assistance system currently being calibrated and/or of incorrectly positioning the currently used calibration panel.

In one example embodiment of the present invention, the identification device comprises an RFID reader which is designed to read identification data from an RFID element which is mounted on the currently used calibration panel. The use of RFID elements mounted on the calibration panels and an RFID reader provided on the holding apparatus to read the RFID elements mounted on the calibration panels means that different calibration panels can be identified simply, quickly and reliably.

In one example embodiment of the present invention, the holding apparatus comprises an output device which allows data and/or instructions to be output to a user of the calibration device. The output device can in particular comprise a display device which allows optical displays to be output to a user. In this way, the user can be shown the current position of the holding apparatus and/or instructions on how to correctly position the holding apparatus. This can further simplify the correct positioning of the holding apparatus and reduce the risk of positioning errors even further.

The output device can also comprise an acoustic output device which indicates, for example by emitting a signal tone, whether the holding apparatus is correctly positioned.

In one example embodiment of the present invention, the holding apparatus comprises an input device which allows data and/or commands to be input into the holding apparatus. The data can comprise, for example, the desired position of the calibration panel and/or the type of calibration panel currently used and/or the type of driver assistance system currently to be calibrated.

In one example embodiment of the present invention, the display device is designed as a touch-sensitive screen (“touchscreen”), so that the display device can also be used as an input device. In one example embodiment of the present invention, the sensor device comprises a first sensor and a second sensor. The first sensor can be designed to provide data which allow the current position of the holding apparatus to be determined along a first direction. The second sensor can be designed to provide data which allow the current position of the holding apparatus to be determined along a second direction.

The second direction is not oriented in parallel with the first direction. The second direction can in particular be oriented orthogonally to the first direction.

The first sensor can, for example, be designed to determine the position of the holding apparatus along a horizontal direction. The second sensor can, for example, be designed to determine the position of the holding apparatus along a vertical direction. The second sensor can in particular be designed to determine the height of the holding apparatus above a floor.

In one example embodiment of a calibration device according to the present invention, a first optically readable scale and a second optically readable scale are formed on the calibration device. In this embodiment, the at least one holding apparatus has a first optical sensor which is designed to determine the current position of the holding apparatus along the first direction by reading the first optically readable scale. The at least one holding apparatus further comprises a second optical sensor which is designed to determine the current position of the holding apparatus along the second direction by reading the second optically readable scale.

With at least two sensors, the position of the holding apparatus and of a measuring panel mounted on the holding apparatus can be determined in two dimensions or directions. The measuring panel mounted on the holding apparatus can thereby be positioned particularly simply and reliably with high accuracy at a specified position in space.

In one example embodiment of the present invention, the calibration panel has an optical code which can be read by at least one optical sensor of the sensor device. The optical code can be, for example, a barcode or a QR code. The optical code can contain information about the calibration panel which allows the calibration panel to be uniquely identified. Alternatively or additionally, the optical code can contain information about the position at which the calibration panel is to be positioned on the support.

In a method according to the present invention for adjusting the position of a calibration panel on a calibration device, the position of the holding apparatus on the support can be changed manually or with the aid of a motor provided in the holding apparatus.

The holding apparatus can be automatically positioned at a specified position by means of a motor. A holding apparatus which does not have a motor and is therefore positioned manually has a lower weight and is more cost-effective than a holding apparatus which is equipped with a motor.

In one example embodiment of the present invention, the method for adjusting the position of the calibration panel on the calibration device comprises uniquely identifying the calibration panel which is mounted on the holding apparatus. The desired target position at which the calibration panel is to be positioned can then be set or determined depending on the identified calibration panel. In this way, different calibration panels provided for calibrating different driver assistance systems can be positioned at the position intended for the calibration panel in question. The risk of incorrect positioning of the calibration panels can thus be reduced.

The method can in particular comprise reading data identifying the calibration panel from an RFID element mounted on the calibration panel. In this way, the calibration panel can be identified particularly simply and reliably.

An exemplary embodiment of the present invention is described below with reference to the figures.

### BRIEF DESCRIPTION OF THE DRAWINGS

FIG. 1 shows a schematic representation of a plan view of a measuring station with a motor vehicle and a calibration device designed according to an example embodiment of the present invention.

FIG. 2 shows a perspective front view of a calibration device designed according to an example embodiment of the present invention.

FIG. 3 shows a perspective view of a holding apparatus designed according to an example embodiment of the present invention.

FIG. 4 shows an example of an optical sensor designed to read a scale mounted on the calibration device and extending in the vertical direction, according to the present invention.

FIG. 5 shows a rear view of a measuring panel mounted on a support, with an optical sensor mounted on the holding apparatus, according to an example embodiment of the present invention.

### DETAILED DESCRIPTION OF EXAMPLE EMBODIMENTS

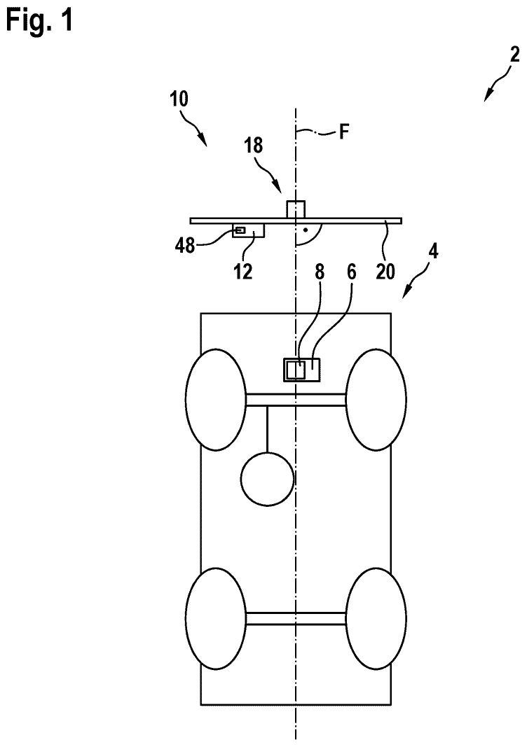

FIG. 1 shows a schematic plan view of a measuring station 2 with a motor vehicle 4 which is equipped with a driver assistance system 6. The driver assistance system 6 comprises an image capture device 8.

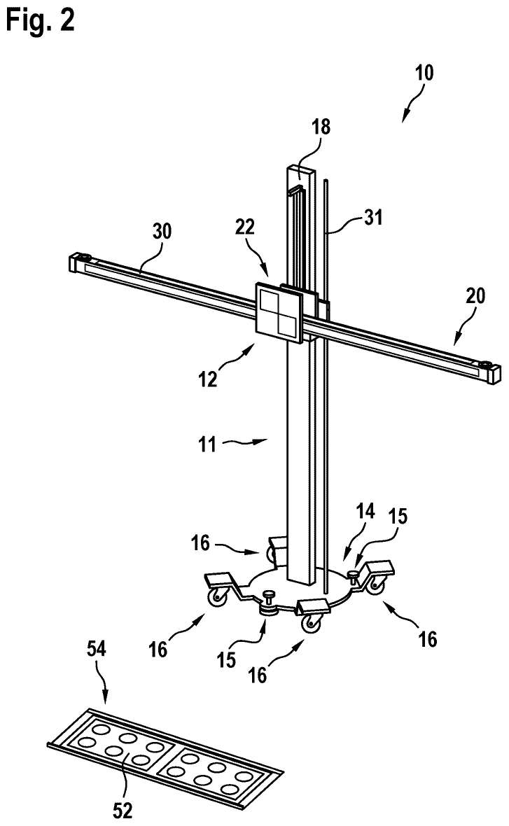

A calibration device 10 is positioned in front of the motor vehicle 4. The calibration device 10 comprises a calibration panel 12, in particular an optical calibration panel 12, with an optical pattern not visible in FIG. 1 (see FIG. 2), which can be optically detected by the image capture device 8 in order to calibrate the driver assistance system 6 and/or the image capture device 8 of the driver assistance system 6. Optionally, an RFID element 48, which makes it possible to identify the calibration panel 12, can be mounted on the calibration panel 12.

The calibration panel 12 is usually oriented orthogonally to the longitudinal axis F of the motor vehicle 4, as shown in FIG. 1.

FIG. 2 shows a perspective view of a calibration device 10 designed according to the present invention with a calibration panel 12 for calibrating a driver assistance system 6 which is installed in a motor vehicle 4, as shown in FIG. 1.

The calibration device 10 comprises a stand 11 with a column 18, which is supported on a base 14 and extends substantially in a vertical direction orthogonally to the floor of the measuring station 2.

The base 14 is equipped with rollers 16 which allow the stand 11 to be moved on the floor of the measuring station 2.

Brakes, not shown in FIG. 2, can be provided on the rollers 16. The brakes can be activated to prevent the stand 11 from rolling away unintentionally after the stand 11 has been positioned in a desired position in front of the motor vehicle 4.

Leveling elements 15 provided on the base 14 make it possible to align the base 14 so that the column 18 extends vertically.

A height-adjustable support 20 or arm is mounted on the column 18 and extends substantially orthogonally to the column 18 in the horizontal direction. The height-adjustable support 20 is mounted on the column 18 such that it can be displaced along the column 18. This allows the height of the support 20 above the floor of the measuring station 2 to be adjusted.

The height-adjustable support 20 can be fixed at different positions along the column 18, i.e., at different heights above the floor of o the measuring station 2.

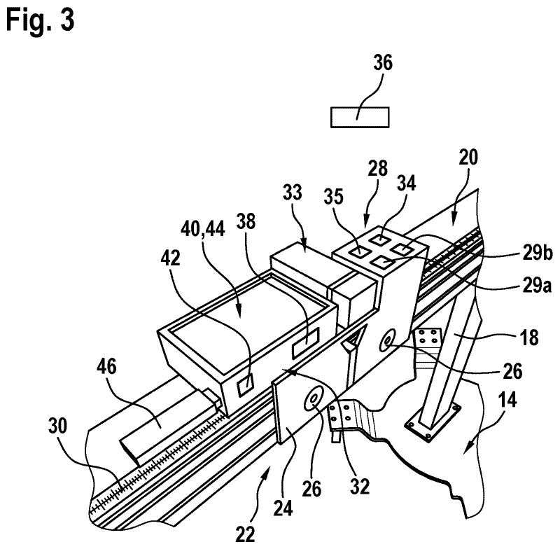

A calibration panel 12 is mounted on the support 20 with the aid of a holding apparatus 22 (see FIG. 3) such that the holding apparatus 22 can be displaced together with the calibration panel 12 along the support 20, i.e., in the horizontal direction. The holding apparatus 22 is covered by the calibration panel 12 in FIG. 2.

The holding apparatus 22 can be fixed in the desired position on the support 20 in order to define the position of the calibration panel 12 along the support 20.

In front of the calibration device 10 there is a mat 54 on which an optical pattern 52 is formed.

FIG. 3 shows a perspective representation of a holding apparatus 22 which is designed according to an exemplary embodiment of the present invention.

The holding apparatus 22 comprises a mechanical connecting device 24 which is designed to connect the holding apparatus 22 to the support 20 and to support it on the support 20 such that the holding apparatus 22 can be displaced along the support 20.

The mechanical connecting device 24 can, for example, be designed as a carriage which can be displaced along the support 20. The mechanical connecting device 24 can also have rollers (not visible in FIG. 3) to improve the mobility of the mechanical connecting device 24 along the support 20.

The mechanical connecting device 24 can also have a releasable fixing device or brake, e.g. a clamping device, which makes it possible to fix, in particular to clamp, the mechanical connecting device 24 in a desired position on the support 20 so that the mechanical connecting device 24 can no longer be displaced along the support 20 when the fixing device or brake is activated.

The mechanical connecting device 24 also has at least one holder 26 which makes it possible to attach a calibration panel 12 (not shown in FIG. 3) (see FIG. 2) to the mechanical connecting device 24.

The holder 26 can, for example, comprise one or more magnets that allow the calibration panel 12 to be attached to the holder 26 by magnetic force. The magnets can be permanent magnets. The magnets can also be electromagnets which can be activated and deactivated electrically, so that the calibration panel 12 can be fixed to the holder 26 by activating the electromagnets and can be easily released from the holder 26 again as required by deactivating the electromagnets.

Alternatively or additionally, the holder 26 can have a mechanical attachment device (not shown in FIG. 3) which makes it possible to mount and fix the calibration panel 12 on the mechanical connecting device 24 mechanically, e.g. by clamping and/or by a form-fitting connection.

The holding apparatus 22 further comprises a sensor device 28 which is designed to provide data which allow the current position of the holding apparatus 22 on the stand 11 to be determined.

The sensor device 28 can, for example, have a (first) optical sensor 29a, in particular a camera, wherein the (first) optical sensor 29a is designed to optically detect or read a scale 30 which is formed on the support 20 in order to be able to determine the current position of the holding apparatus 22 along the support 20.

The scale 30 can, for example, be designed as an optically readable rule that can also be read by a human, as shown in FIG. 3. The scale 30 can also have numbers (not shown in FIG. 3).

Alternatively or additionally, the scale 30 can be designed as a well machine-readable code, for example as a barcode. The scale 30 can also be designed such that it can be read by a magnetic sensor 29a and/or by a mechanical sensor 29a.

Optionally, the sensor device 28 can also comprise a second sensor 29b, which is designed to determine the height of the holding apparatus 22 above the floor of the measuring station 2.

The second sensor 29b can, for example, be a further optical sensor which is designed to read a second scale 31 (see FIG. 2) mounted on the calibration device 10 and extending in the vertical direction.

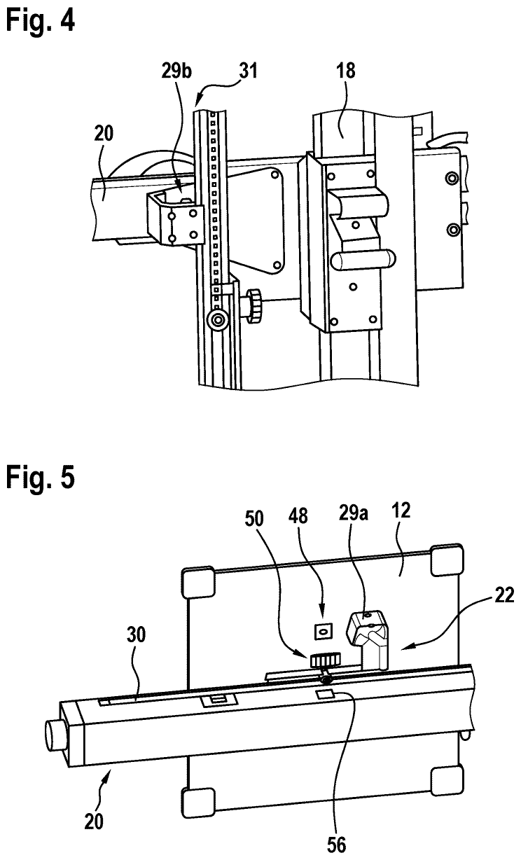

FIG. 4 shows an exemplary embodiment of a second optical sensor 29b, which is designed to read a second scale 31 mounted on the calibration device 10 and extending in the vertical direction.

At least one of the first optical sensor 29a and the second optical sensor 29b can be designed to optically detect an optical code 50, for example a barcode or a QR code, which is formed on the calibration panel 12, in order to allow the calibration panel 12 to be identified using the optical code 50 mounted on the calibration panel 12. The optical code 50 can in particular be formed on a rear side of the calibration panel 12, which faces one of the optical sensors 29a, 29b when the measuring panel 12 is mounted on the holding apparatus 22.

FIG. 5 shows a rear view of a measuring panel 12 mounted on a support 20. FIG. 5 also shows a holding apparatus 22 with a first optical sensor 29a, which is able to read a scale 30 formed on the support 20 in order to be able to determine the position of the holding apparatus 22 with the measuring panel 12 along the support 20.

The first optical sensor 29a is also able to capture an image of an optical code 50 provided on the rear side of the measuring panel 12, so that the measuring panel 12 can be uniquely identified using the image of the optical code 50 captured by the first optical sensor 29a.

At least one of the first optical sensor 29a and the second optical sensor 29b can also be designed to detect an optical pattern 52 which is formed on the floor of the measuring station 2 in front of the calibration device 10 in order to be able to determine the position of the optical pattern 52 on the floor of the measuring station 2. The optical pattern 52 can, for example, be provided to calibrate cameras, in particular rear-view cameras of the motor vehicle.

The optical pattern 52 can in particular be formed on a mat 54 which is placed in front of the calibration device 10 on the floor of the measuring station 2, as shown in FIG. 2.

At least one angle sensor 56, which makes it possible to determine the roll angle and/or pitch angle of the support 20, can also be provided on the support 20 or on the holding apparatus 22. The angle sensor 56 can comprise an acceleration sensor which detects the effect of gravitational acceleration (gravity) on the angle sensor 56.

Two angle sensors 56 can also be provided, one of which is designed to determine the roll angle of the support 20, and the other of which is designed to determine the pitch angle of the support 20.

The at least one angle sensor 56 can be designed to transmit its measurement result wirelessly, e.g. via WLAN or Bluetooth®, or in a wired manner, e.g. via a USB connection, to the sensor device 28 or to an external evaluation device.

The at least one angle sensor 56 can also be equipped with an angle sensor display device, for example with an LCD display or with an LED display, wherein the angle sensor display device is arranged in the field of view of one of the optical sensors 29a, 29b such that values displayed on the angle sensor display device can be read by the optical sensor 29a, 29b. In this way, the measured values ascertained by the at least one angle sensor 56 can be read by the optical sensor 29a, 29b and made available for evaluation.

The second sensor 29b can also be designed as a magnetic sensor or as a mechanical sensor in order to read a correspondingly designed magnetic or mechanical second scale 31.

The second sensor 29b can also be designed as an ultrasonic sensor, which makes it possible to determine the height of the holding apparatus 22 above the floor of the measuring station 2 by measuring the transit time of an ultrasonic signal between the second sensor 29b and the floor of the measuring station 2. If the second sensor 29b is designed as an ultrasonic sensor, the second scale 31 can be dispensed with.

The holding apparatus 22 also comprises a data transmission device 34, in particular a transmitting device, which is designed to transmit the data which is provided by the sensor device 28 and make it possible to determine the current position of the holding apparatus 22 on the support 20, and in this way to transmit said data to an external device 36.

Optionally, the holding apparatus 22 can also comprise a receiving device 35 which allows data to be received from the external device 36.

The data can in particular be transmitted wirelessly, for example via a Bluetooth® connection, a WLAN connection or a radio connection in the UHF band. Alternatively, the data can also be transmitted via a cable connection (not shown in the figures), e.g. via a USB connection or another serial data connection, between the holding apparatus 22 and the external device 36.

Both the data provided by the sensor device 28 (“raw data”) and data processed in a control unit 32 of the holding apparatus 22 can be transmitted to the external device 36.

The control unit 32 can in particular comprise a data processing device 38, for example with a microprocessor, which is designed to process the raw data supplied by the at least one sensor device 28 in order to determine the current position of the holding apparatus 22 on the stand 11. When processing data, both computer-aided image processing and image evaluation methods, such as computer-aided pattern recognition, and artificial intelligence (“deep learning”) methods can be used.

In the exemplary embodiment shown in FIG. 3, the holding apparatus 22 also has a display device 40 which makes it possible to display data supplied by the sensor device 28 and/or data provided by the data processing device 38 in such a way that said data can be read by a user.

In particular, the current position of the holding apparatus 22 along the support 20, as determined from the data supplied by the sensor device 28, can be displayed on the display device 40. If it has been determined by the sensor device 28, the height of the holding apparatus 22 above the floor of the measuring station 2 can also be displayed.

Optionally, a target position at which the holding apparatus 22 is to be positioned can also be displayed. In this case, the difference between the current position and the target position and/or instructions to the user for moving the holding apparatus 22 along the support 20 or along the column 18 can also be displayed. For example, arrows can be displayed on the display device 40 to inform the user of the direction in which the holding apparatus 22 must be moved in order to position it at a specified target position.

The display device 40 can also display a confirmation that the current position of the holding apparatus 22 is correct when the holding apparatus 22 is at the desired target position. The confirmation and/or the instructions for moving the holding apparatus 22 can alternatively or additionally be output as acoustic signals by an acoustic output device 42.

The holding apparatus 22 can also have an input device 44, e.g. a keyboard, which allows the user to input data, e.g. a desired target position and/or information about the calibration panel 12 currently used and/or information about the driver assistance system 6 to be calibrated.

The display device 40 can in particular be designed as a touch-sensitive screen (“touchscreen”), so that the display device 40 can also be used as an input device 44.

The holding apparatus 22 can additionally have a calibration panel identification device 46 which makes it possible to identify a calibration panel 12 mounted on the holding apparatus 22.

The identification device 46 can, for example, comprise an RFID reader which is designed to read identification data from an RFID element 48 (see FIG. 1) which is mounted on the calibration panel 12.

An identification device 46 for reading data from an RFID element 48 mounted on the calibration panel 12 is not required if the identification of the calibration panel 12 is carried out by an optical code 50 which is mounted on the calibration panel 12 or formed on the calibration panel 12 and can be read by one of the optical sensors 29a, 29b, as described above.

The identification data can in particular comprise information about the calibration panel 12 which can be used to calibrate the driver assistance system 6. The identification data can also contain information about the correct position of the calibration panel 12 on the calibration device 10.

The identification data can also contain an identifier which uniquely identifies the calibration panel 12, thus making it possible to take the data required to calibrate the driver assistance system 6 from a table (“look-up table”) and/or from a database in which the required data for a plurality of optical calibration panels 12 are stored.

This table or database can be stored locally in the holding apparatus 22. The table or database can also be stored separately from the holding apparatus 22, e.g. in the external device 36, and can be accessed via the data connection. The table or database can also be stored outside the measuring station 2, in particular in a central server of the manufacturer, and can be accessed, for example, via the Internet. It is also possible for a local database with the required data to be stored in the external device 36 and to be updated as required or at regular intervals, e.g. via the Internet.

The identification device 46 can be designed to be pluggable, e.g. in the form of a USB connector, so that the holding apparatus 22 can be specifically equipped with an identification device 46 by plugging in the identification device 46 if this is desired, in particular if the calibration device 10 is used alternately with different calibration panels 12.

A pluggable identification device 46 makes it possible to provide the identification device 46 as an option, wherein the identification device 46 can be omitted in order to reduce the costs for the calibration device 10 if no identification device 46 is required, e.g. because the calibration device 10 is always used with the same calibration panel 12.

The holding apparatus 22 also comprises a control unit 32, which comprises, for example, the data processing device 38 for processing the data supplied by the at least one sensor device 28. The control unit 32 can also be designed to control the sensor device 28, the transmitting device 34, the receiving device 35, the display device 40, the acoustic output device 42, the input device 44 and the identification device 46 and to coordinate the communication between these devices 28, 34, 35, 40, 42, 44.

The holding apparatus 22 can also comprise an electrical energy source 33, e.g. an electrical accumulator, an electrical battery or a solar cell, which is designed to supply the sensor device 28, the transmitting device 34, the receiving device 35, the display device 40, the acoustic output device 42, the input device 44 and the identification device 46 with electrical energy.

Alternatively, the sensor device 28, the transmitting device 34, the receiving device 35, the display device 40, the acoustic output device 42, the input device 44 and the identification device 46 can also be supplied with electrical energy via a cable connection (not shown in the figures), for example a USB cable, from an external energy source, in particular from an electrical power supply unit.

With a holding apparatus 22 according to the present invention, the positioning of a calibration panel 12 on a calibration device 10 can be considerably simplified. In addition, the risk of incorrect positioning of the calibration panel 12 and thus the risk of incorrect calibration of the driver assistance system 6 can be significantly reduced. In this way, the reliability of the calibration can be significantly improved.

1-15. (canceled)

16. A holding apparatus for mounting and holding a calibration panel on a stand, the holding apparatus comprising:
a mechanical connecting device configured to mechanically connect the holding apparatus to the stand;
a holder which allows the calibration panel to be mounted on the holding apparatus;
a sensor device configured to provide data which allow the current position of the holding apparatus on the stand to be determined; and
(i) a transmitting device configured to transmit the data which allow a current position of the holding apparatus to be determined, and/or (ii) an output device configured to make it possible to output the data which allow the current position of the holding apparatus to be determined, wherein the output device includes a display device.

17. The holding apparatus according to claim 16, wherein the sensor device includes at least one optical sensor.

18. The holding apparatus according to claim 17, wherein the holding apparatus has at least one optical sensor which is configured to detect an optical pattern formed on a floor in order to be able to determine a position of the optical pattern on the floor.

19. The holding apparatus according to claim 17, wherein:
the holding apparatus has at least one angle sensor which allows a roll angle and/or pitch angle of the support to be determined;
the at least one angle sensor is equipped with an angle sensor display device which can be read by an optical sensor of the holding apparatus.

20. The holding apparatus according to claim 16, wherein the holding apparatus further comprises a data processing device which is configured to process the data supplied by the sensor device in order to determine the current position of the holding apparatus.

21. The holding apparatus according to claim 16, wherein:
the holding apparatus further comprises an identification device which makes it possible to identify a calibration panel arranged in the holder of the holding apparatus;
the identification device includes an RFID reader which is configured to read identification data from an RFID element.

22. The holding apparatus according to claim 16, further comprising an input device which allows data and/or commands to be input into the holding apparatus.

23. The holding apparatus according to claim 16, wherein:
the sensor device includes a first sensor and a second sensor;
the first sensor is configured to provide data which allow the current position of the holding apparatus to be determined along a first direction;
the second sensor is configured to provide data which allow the current position of the holding apparatus to be determined along a second direction which is not oriented in parallel with the first direction;
the second direction is oriented orthogonally to the first direction.

24. A calibration device for calibrating an image capture device of a driver assistance system, the calibration device comprising:
a stand; and
at least one holding apparatus which can be mounted movably on the stand, each of the at least one holding apparatus including:
a mechanical connecting device configured to mechanically connect the holding apparatus to the stand,
a holder which allows the calibration panel to be mounted on the holding apparatus,
a sensor device configured to provide data which allow the current position of the holding apparatus on the stand to be determined, and
(i) a transmitting device configured to transmit the data which allow a current position of the holding apparatus to be determined, and/or (ii) an output device configured to make it possible to output the data which allow the current position of the holding apparatus to be determined, wherein the output device includes a display device;
wherein the calibration device includes a support which is mounted on the stand in a height-adjustable manner, and wherein the at least one holding apparatus can be mounted movably on the height-adjustable support.

25. The calibration device according to claim 24, wherein:
at least one optically readable scale is formed on the stand; and
the at least one holding apparatus has at least one optical sensor which is configured to determine the current position of the holding apparatus on the stand by reading the at least one optically readable scale.

26. The calibration device according to claim 25, wherein:
the stand has a first optically readable scale and a second optically readable scale;
the at least one holding apparatus has a first optical sensor which is configured to determine the current position of the holding apparatus along a first direction by reading the first optically readable scale;
the at least one holding apparatus has a second optical sensor which is configured to determine the current position of the holding apparatus along a second direction by reading the second optically readable scale; and
the second direction is not oriented in parallel with the first direction, wherein the second direction is oriented orthogonally to the first direction.

27. The calibration device according to claim 24, further comprising:
at least one calibration panel which can be arranged on or in the holder of the holding apparatus;
wherein:
the calibration panel has an RFID element which contains information about the calibration panel and/or about a specified position of the calibration panel on the calibration device; and/or
the calibration panel has an optical code which can be read by an optical sensor of the holding apparatus, wherein the optical code contains information about the calibration panel and/or about a specified position of the calibration panel on the calibration device.

28. A method for determining a position of a calibration panel on a calibration device, the calibration device including:
a stand, and
at least one holding apparatus which can be mounted movably on the stand, each of the at least one holding apparatus including:
a mechanical connecting device configured to mechanically connect the holding apparatus to the stand,
a holder which allows the calibration panel to be mounted on the holding apparatus,
a sensor device configured to provide data which allow the current position of the holding apparatus on the stand to be determined, and
(i) a transmitting device configured to transmit the data which allow a current position of the holding apparatus to be determined, and/or (ii) an output device configured to make it possible to output the data which allow the current position of the holding apparatus to be determined, wherein the output device includes a display device,
wherein the calibration device includes a support which is mounted on the stand in a height-adjustable manner, and wherein the at least one holding apparatus can be mounted movably on the height-adjustable support,
the method comprising the following steps:
arranging the calibration panel on or in the holder of the holding apparatus and determining the position of the holding apparatus on the calibration device using the sensor device; and
(i) transmitting data which represent the determined position of the holding apparatus on the calibration device using the transmitting device, and/or (ii) outputting or displaying the data using the output device.

29. A method for positioning a calibration panel on a calibration device, the calibration device including:
a stand, and
at least one holding apparatus which can be mounted movably on the stand, each of the at least one holding apparatus including:
a mechanical connecting device configured to mechanically connect the holding apparatus to the stand,
a holder which allows the calibration panel to be mounted on the holding apparatus,
a sensor device configured to provide data which allow the current position of the holding apparatus on the stand to be determined, and
(i) a transmitting device configured to transmit the data which allow a current position of the holding apparatus to be determined, and/or (ii) an output device configured to make it possible to output the data which allow the current position of the holding apparatus to be determined, wherein the output device includes a display device,
wherein the calibration device includes a support which is mounted on the stand in a height-adjustable manner, and wherein the at least one holding apparatus can be mounted movably on the height-adjustable support,
the method comprising the following steps:
determining the position of the holding apparatus on the calibration device by:
arranging the calibration panel on or in the holder of the holding apparatus and determining the position of the holding apparatus on the calibration device using the sensor device, and
(i) transmitting data which represent the determined position of the holding apparatus on the calibration device using the transmitting device, and/or
(ii) outputting or displaying the data using the output device; and
changing the position of the holding apparatus until the determined position of the holding apparatus corresponds to a specified position, including: (i) changing the position of the holding apparatus by motor or (ii) changing the position of the holding apparatus manually.

30. The method according to claim 29, wherein the method further comprises:
identifying the calibration panel including:
(i) reading data from an RFID element mounted on the calibration panel, which data identify the calibration panel and/or a specified position of the calibration panel on the calibration device; and/or
(ii) using an optical sensor to detect an optical code mounted on the calibration panel, wherein the optical code contains information which uniquely identifies the calibration panel and/or a specified position of the calibration panel on the calibration device.
